(19) United States
(12) Patent Application Publication
(10) Pub. No.: US 2011/0216760 A1
(43) Pub. Date: Sep. 8, 2011

(54) SYSTEM AND METHOD FOR WEIGHTED MULTI-ROUTE SELECTION IN IP TELEPHONY

(76) Inventors: Jim Murphy, Bell Canyon, CA (US); Arash Ramezani, Topanga, CA (US)

(21) Appl. No.: 12/717,836

(22) Filed: Mar. 4, 2010

(51) Int. Cl. H04L 12/66

(52) U.S. Cl. 370/352

(57) ABSTRACT

Systems and methods can be used for selecting eligible egress routes for IP telephony termination when multiple eligible carriers exist. The method uses any of a variety of factors to determine eligible egress routes, including for example, cost, eligibility and carrier relationship as determining factors. The disclosed method includes returning multiple routes for route advancement to a next most preferred carrier in the event of preferred carrier failure.

### BACKGROUND

Voice over Internet Protocol (VoIP) is a general term for a family of transmission technologies for delivery of voice communications over IP networks such as the Internet or other packet-switched networks. The use of VoIP is growing at a rapid pace and there is a need for systems and methods for efficiently routing VoIP communications over a network.

### SUMMARY

Disclosed are systems and methods for selecting eligible egress routes for IP telephony termination when multiple eligible carriers exist. The method uses any of a variety of factors to determine eligible egress routes, including for example, cost, eligibility and carrier relationship as determining factors. It should be appreciated that the aforementioned factors are just examples and that other factors can be taken into account when determining eligible egress routes. The disclosed method includes returning multiple routes for route advancement to a next most preferred carrier in the event of preferred carrier failure.

In one aspect, there is disclosed a method of selecting a carrier for routing a telephone call, comprising: identifying a list of eligible carriers; identifying a plurality selection factors related to each eligible carrier; evaluating the factors relative to each carrier; assigning a score to each of the carriers based on the evaluation; and selecting the carrier with the highest score to route the call.

The details of one or more implementations are set forth in the accompanying drawings and the description below. Further features, aspects, and advantages will become apparent from the description, the drawings, and the claims.

### BRIEF DESCRIPTION OF THE DRAWINGS

FIG. 1 shows a high-level, schematic diagram of an exemplary embodiment of a telecommunications network that enables communications between devices communicatively connected to the network in accordance with the present disclosure.

FIG. 2 shows a flow chart of a high level process for selecting eligible egress routes for IP telephony termination.

FIG. 3 shows a flow chart of an exemplary method of weighted multi-route selection in IP telephony.

### DETAILED DESCRIPTION

Disclosed are systems and methods for selecting eligible egress routes for IP telephony termination when multiple eligible carriers exist. The method uses any of a variety of factors to determine eligible egress routes, including for example, cost, eligibility and carrier relationship as determining factors. It should be appreciated that the aforementioned factors are just examples and that other factors can be taken into account when determining eligible egress routes. The disclosed method includes returning multiple routes for route advancement to a next most preferred carrier in the event of preferred carrier failure.

Before the present subject matter is further described, it is to be understood that this subject matter described herein is not limited to particular embodiments described, as such may of course vary. It is also to be understood that the terminology used herein is for the purpose of describing particular embodiments only, and is not intended to be limiting. Unless defined otherwise, all technical terms used herein have the same meaning as commonly understood by one skilled in the art to which this subject matter belongs.

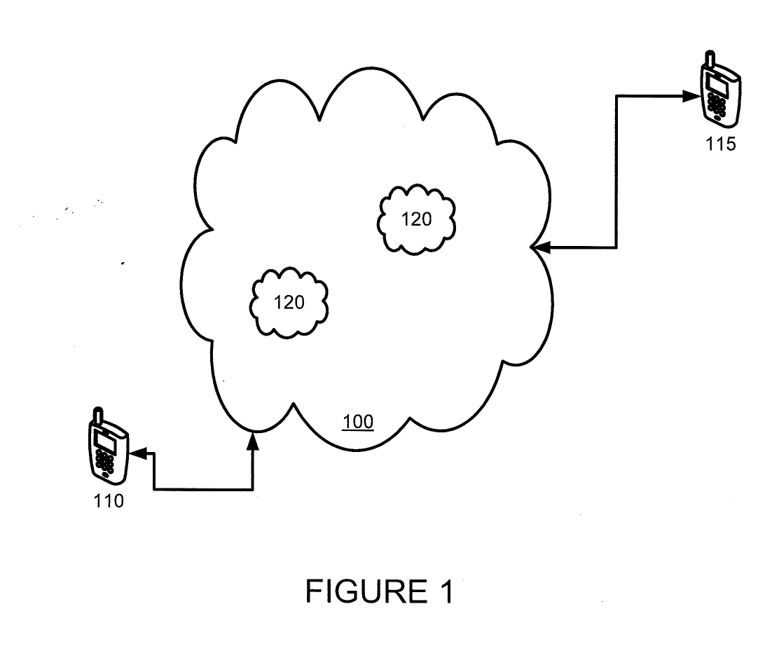

FIG. 1 shows a high-level, schematic diagram of an exemplary embodiment of a telecommunications network 100 that enables communications between devices communicatively connected to the network in accordance with the present disclosure. The network 100 can comprise, for example, a common or private bi-directional telecommunications network (e.g., a public switched telephone network (PSTN), cellular network, a cable-based telecommunication network, a LAN, a WAN, a wireless network, or combinations thereof), coupled with or overlayed by a TCP/IP network (e.g., the Internet or an intranet).

At least a first telecommunications device 110 and a second telecommunications device 115 are communicatively linked to the network 100. The telecommunications devices can be any types of devices that are configured to communicate with the network and to establish communication links with one another over the network 100. The telecommunications devices are described herein the in context of being a first VoIP-enabled telephone 110 and a second VoIP-enabled telephone 115, although the type of communications device can vary. For example, the telecommunications devices can be anything (e.g., computers, personal digital assistants, land-line telephones, etc.) configured to transmit and receive any type of data over a network.

Each telecommunications device has at least one address (such as a telephone number) that points to a network location where a communication link can be established with the telecommunications device via the network 100. It should be appreciated, that the addresses of the communications devices are not limited to being telephone numbers, but can include other types of addresses, such as, for example, a Session Initiated Protocol (SIP) Uniform Resource Identifier (URI), an instant message nickname, a shorthand descriptor of a group of other addresses, or any identifier that points to a location or node on the network where a communication link can be established.

The network 100 includes or is coupled to one or more carriers 120 that provide communication services to the telephones 110 and 115. A carrier may be, for example, a Local Exchange carrier (LEC), a Competitive Local Exchange carrier (CLEC), a wireless telephony carrier, a VoIP provider, or any other network which provides endpoint-to-endpoint communications between subscribing devices such as the telephones 110, 115. Each telephone 110 and 115 may be associated with a carrier 120 such that the carrier 120 provides communication access to and over the network 100.

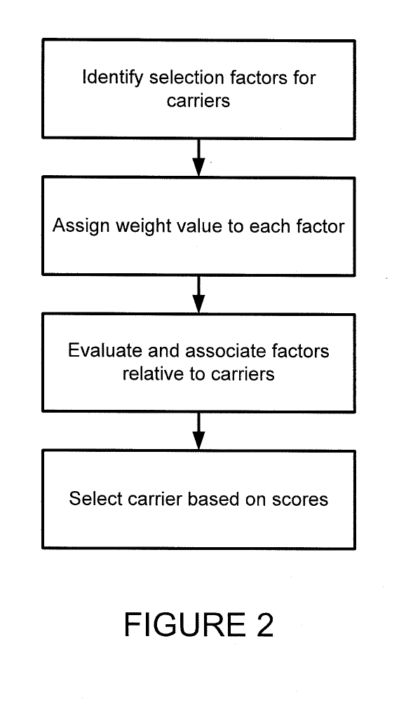

Pursuant to this disclosure, there is provided a method for selecting eligible egress routes for IP telephony termination when multiple eligible carriers 120 exist. With reference to FIG. 2, there is now described an exemplary high level process for selecting an eligible carrier. In a first step, any of a plurality of criteria or factors may be identified for selecting an eligible carrier. For example, the factors can include, but are not limited to, dollar cost of a carrier, quality of the carrier, administrative preferences associated with a carrier, contractual agreements, etc. In a next step, a weight value may be associated with each one of the factors being considered. The weight value permits one or more of the factors to be weighted either higher or lower than the other factors during the carrier selection process. In this manner, one or more of the factors can be assigned a higher or lower “importance” in the selection criteria relative to the other factors. In a next step, the factors being considered are each evaluated and associated with the eligible carriers. This enables a “score” to be assigned to each one of the carriers being evaluated. Finally, a carrier is selected based on how each one of the carriers scored in the selection process.

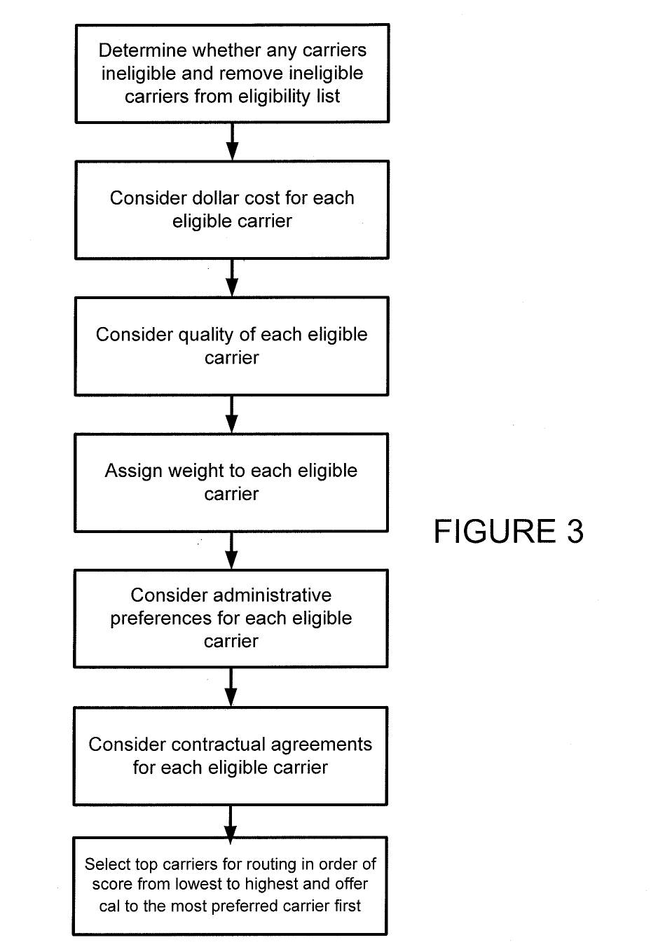

An exemplary method of selecting eligible egress routes is now described in an exemplary chronological order with reference to FIG. 3. It should be appreciated that the order of the steps is merely exemplary and that the steps can be performed in a wide variety of orders. Pursuant to the method described above, a variety of factors are considered as to which carrier should be used for routing a call. Each factor is considered and a weight value is assigned to each factor and associated with the eligible carriers. The factors and weight values may be tabulated for example in a table for selecting the eligible carrier.

In an initial step, a determination is made as to whether any carriers are ineligible for carrying telephone traffic. If it is determined that any carriers are ineligible, then the ineligible carrier is removed from an eligibility list. In an exemplary embodiment, a table is formed that includes a list of all peered carriers matched with the highest unique dial-able digit. If a carrier is able to route to the desired number block then the carrier is assigned to that number block. This may lead to each number block having more than one carrier assigned to a particular number block.

It has now been determined which carriers are eligible for routing the call. In a next step, the cost (such as dollar cost) for each carrier relative to a particular number block is considered and analyzed. The cost for each carrier may vary based on whether the call is interstate or intrastate. However, the cost variance often may not be determined until after the call is placed. In this regard, a pair of separate tables may be tabulated wherein one table is associated with the interstate cost for a carrier relative to the number block and a second table is associated with the intrastate cost for a carrier relative to the number block.

Another factor that is considered is the quality of the carrier. In this regard, it may be determined that a particular carrier is capable of providing a higher quality of call routing than another carrier. Quality can be defined in various manners. In an embodiment, quality is defined as either as a score derived from historical sampling of ASR (Answer to Seizure Ratio) and MOS (Mean Opinion Score) statistics or as an arbitrary value that represents the minimum ASR and MOS scores that the carrier guarantees. In a next step of the process, a weight is assigned to each carrier such as in the form of a multiplier on a per number block basis. This permits the system to add preference to routes where a carrier provides higher quality such as where the carrier has physical ownership of the lines versus same-carrier routes where the carrier is reselling to another carrier. In an embodiment, the weighting process may also be used to balance traffic based on external mitigating factors such as available bandwidth and traffic exchange agreements that are not necessarily represented by cost-based routing alone. The weighted multiplier may be applied individually to dial blocks on both the interstate and intrastate tables on a per-carrier level.

Another factor that may be considered in selecting the carrier is whether there are any internal administrative preferences for a particular carrier or carriers. For example, a decimal modifier may be used to represent the respective administrative preference of the route. This may be, for example, a simple 0-10 modifier added to the resulting score to act as a tie-breaker in the case two routes end up with the exact same preference score.

It is next determined whether there are any contractual agreements with any carriers that would favor routing with a particular carrier. For example, contractual arrangements may exist that a certain minute volume must be met with a specific carrier. If any such contractual agreements exist, then that will be factored into the carrier rankings. For example, a carriers with such a “minute commitment” may immediately be moved to the top or nearer to the top priority slot for the list of eligible carriers. In the event multiple carriers have a minute quota, such carriers are ranked in descending order of their routing score, then non-quota-bearing carriers will be ranked after quota-bearing carriers.

In order to speed the route decision process, a table of pre-built routes may be constructed for both Interstate and Intrastate routing. This is done by taking the associated costs for each carrier to each number block, multiplying the cost by the weight, adding the administrative preference and then ranking the carriers per block in order of descending resulting score. In order to maintain routing table accuracy in the face of changing rates and quota measurements, the route cache will be rebuilt at regular intervals in conjunction with call mediation for quote fulfillment.

The following steps take place in real-time during call processing. When the call is offered to the routing server the calling and called numbers are evaluated to determine if the call will be interstate or intrastate. The appropriate route cache is now consulted (Interstate or Intrastate) and the block in which the called number resides is located. The top N carriers are selected for routing in order of score from lowest (indicating the most preferred) to highest (indicating the least preferred). The call is offered to the most preferred carrier first, and in the event that carrier is unable to accept the call, and it is rejected, instead of the call failing it is offered to the next most preferred carrier. This process can repeat as long as there are un-tried routes.

As will be apparent to those of skill in the art upon reading this disclosure, each of the individual embodiments described and illustrated herein has discrete components and features which may be readily separated from or combined with the features of any of the other several embodiments without departing from the scope of the subject matter described herein. Any recited method can be carried out in the order of events recited or in any other order which is logically possible.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Although embodiments of various methods and devices are described herein in detail with reference to certain versions, it should be appreciated that other versions, embodiments, methods of use, and combinations thereof are also possible. Therefore the spirit and scope of the appended claims should not be limited to the description of the embodiments contained herein.

What is claimed:

1. A method of selecting a carrier for routing a telephone call, comprising:
identifying a list of eligible carriers;
identifying a plurality selection factors related to each eligible carrier;
evaluating the factors relative to each carrier;
assigning a score to each of the carriers based on the evaluation;
selecting the carrier with the highest score to route the call.

2. A method as in claim 1, wherein the selection factors include dollar cost of a carrier, quality of the carrier, administrative preferences associated with a carrier, and contractual agreements with the carriers.

3. A method as in claim 1, wherein the telephone call is a VoIP call.

4. A method as in claim 1, further comprising assigning a weight value to each one of the factors.

5. A method as in claim 1, further comprising selecting the carrier with the next highest score to route the call if the carrier with the highest score is unable to route the call.

6. A method as in claim 1, further comprising removing ineligible carriers from a priority list.
